(19) United States
(12) Patent Application Publication
(10) Pub. No.: US 2025/0242559 A1
(43) Pub. Date: Jul. 31, 2025

(54) TIRE SEALANT INJECTOR

(71) Applicant: Stan’s Performance Products, LLC, Big Flats, NY (US)

(72) Inventors: Derek Bissett, Boalsburg, PA (US); Andrew Hanna, Morgantown, WV (US)

(21) Appl. No.: 19/041,341

(22) Filed: Jan. 30, 2025

Related U.S. Application Data
(60) Provisional application No. 63/627,181, filed on Jan. 31, 2024.

(51) Int. Cl. B29C 73/16; B29L 30/00; B60C 17/00

(52) U.S. Cl. CPC B29C 73/166; B60C 17/00; B29L 2030/00

(57) ABSTRACT

Liquid tire sealants are messy and difficult to apply using conventional re-loadable injectors and varied valve stem sizes and styles. The reloadable tire sealant injectors disclosed herein incorporate easy start plungers and/or chucks capable of interference fit with one or more of Schrader, Presta, Dunlop, or custom valve stems. A tapered-entry barrel permits a plunger to be inserted with a minimum of mess. Interference fit chucks are used with at least Schrader and Presta valve stems without re-configuration, and minimize mess, as compared to conventional designs.

### CROSS-REFERENCE TO RELATED APPLICATIONS

The present application claims benefit of priority to U.S. Provisional Patent Application No. 63/627, 181, entitled “TIRE SEALANT INJECTOR,” and filed on Jan. 31, 2024, which is specifically incorporated by reference herein for all that it discloses or teaches.

### BACKGROUND

Tubeless bicycle tire systems require a compatible tire, a rim capable of being sealed at the valve stem, sealed spoke holes (if they go all the way through the rim), and a tire bead seat. Liquid sealant is often added inside the tire to prevent leaking around the bead seats, valve stem, and/or spoke holes, and to seal holes from small punctures. However, such sealants can be messy and difficult to apply using re-loadable injectors and varied valve stem sizes and styles.

### SUMMARY

Implementations described and claimed herein address the problems described herein by providing a reloadable tire sealant injector. The injector comprises a barrel to receive liquid tire sealant, the barrel including a priming section including an open end and a main section including a discharge port. The injector further comprises a vent port that defines a transition between the priming section and the main section of the barrel, and a plunger. The plunger is to be inserted into the open end of the priming section, depressed through the priming section to vent air through the vent port, depressed past the vent port to pressurize the barrel, and depressed through the main section to discharge the liquid tire sealant from the barrel through the discharge port.

Implementations described and claimed herein further address the problems described herein by providing an interference fit chuck for a tire sealant injector. The interference fit chuck comprises a resilient housing including a first section to interference fit with a first valve stem type, and a second section to interference fit with a second valve stem type. The interference fit chuck further comprises a relief valve within the resilient housing to hold liquid sealant within the resilient housing when less than an actuation pressure is applied, and release the liquid sealant when greater than the actuation pressure is applied.

Other implementations are also described and recited herein.

### BRIEF DESCRIPTION OF THE DRAWINGS

FIG. 1 illustrates an example reloadable tire sealant injector with a tapered-entry barrel and an interference fit chuck.

FIG. 2 illustrates a partial perspective sectional view of an example tapered-entry barrel for a reloadable tire sealant injector.

FIG. 3 illustrates an open end of another example tapered-entry barrel for a reloadable tire sealant injector.

FIG. 4A illustrates a partial elevation sectional view of a plunger removed from a tapered-entry barrel of an example reloadable tire sealant injector.

FIG. 4B illustrates the plunger positioned within the tapered-entry barrel and above an annular bump of the example reloadable tire sealant injector of FIG. 4A.

FIG. 4C illustrates the plunger positioned within the tapered-entry barrel and below the annular bump of the example reloadable tire sealant injector of FIGS. 4A and 4B.

FIG. 5A illustrates a partial elevation sectional view of a plunger positioned within a barrel and above an annular bump of another example reloadable tire sealant injector.

FIG. 5B illustrates the plunger positioned within the barrel and below the annular bump of the example reloadable tire sealant injector of FIG. 5A.

FIG. 6 illustrates a perspective sectional view of an example interference fit chuck for a reloadable tire sealant injector.

FIG. 7 illustrates an exploded perspective sectional view of another example interference fit chuck for a reloadable tire sealant injector.

FIG. 8 illustrates a sectional view of another example interference fit chuck for a reloadable tire sealant injector attached to a Schrader valve stem.

FIG. 9 illustrates a sectional view of another example interference fit chuck for a reloadable tire sealant injector attached to a Presta valve stem.

FIG. 10 illustrates example operations for using a reloadable tire sealant injector to seal a pneumatic tubeless bicycle tire.

### DETAILED DESCRIPTION

Bicycle and other pneumatic tires are commonly equipped with one of three styles of valve stems, Schrader (American), Presta (French), or Dunlop (Woods or English) style valves, referred to herein as Schrader, Presta, or Dunlop valves, respectively. Sealant is often added to pneumatic tires using a syringe-style injector and output hose screwed, interference fit, or otherwise attached to the valve stem. The output hose may have a tip outer diameter (OD) small enough to fit within the inner diameter (ID) of a valve stem or a tip ID large enough to fit over the OD of the valve stem. The syringe can then be used to inject sealant into a deflated tire with a corresponding valve core removed from the valve stem.

This presently disclosed technology is directed to new and improved reloadable tire sealant injectors with easy start plungers and/or chucks capable of interference fit with one or more of Schrader, Presta, Dunlop, or custom valve stems. The presently disclosed tapered-entry barrel include features that permit a plunger to be inserted with a minimum of mess. The presently disclosed interference fit chucks are used with at least Schrader and Presta valve stems without re-configuration, while minimizing mess, when compared to prior designs.

The presently disclosed technology uses bicycle pneumatic tubeless tires as example objects to be sealed. However, a wide range of other pneumatic objects, including but not limited to pneumatic tubed and tubeless tires, may also be sealed using the reloadable tire sealant injector with tapered-entry barrel and interference fit chuck, and associated systems and methods, described herein. The disclosed interference fit chucks may interface with a variety of valve stem types, such as Schrader, Presta, or Dunlop valves, or custom valve designs. Further, the reloadable tire sealant injector with tapered-entry barrel and interference fit chuck may use a variety of commercially available liquid sealants.

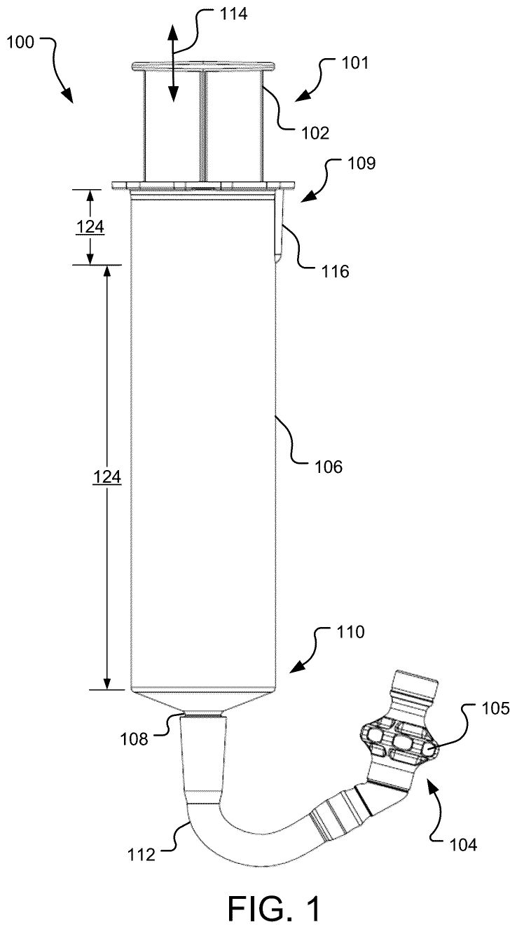

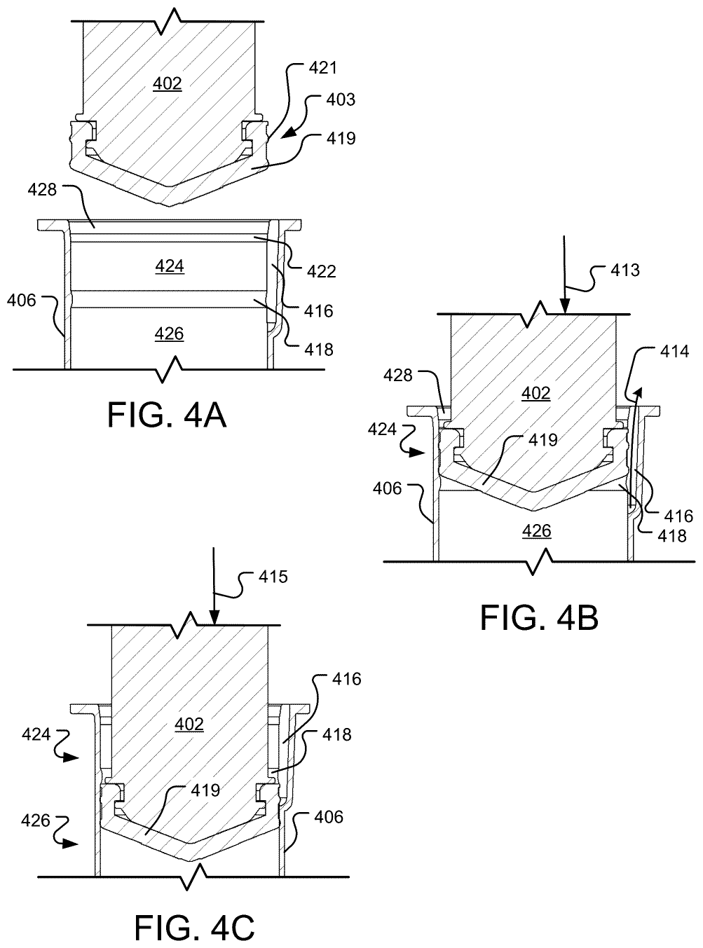

FIG. 1 illustrates a reloadable tire sealant injector 100 with an easy-start, tapered-entry barrel 106 and an interference fit chuck 104. The injector 100 includes a pump including plunger (or piston) 102 fit tightly within the barrel 106. The plunger 102 includes a depicted handle end 101 and an opposing plunger end (not shown, see e.g., plunger end of FIGS. 4A-4C) that interfaces with the barrel 106.

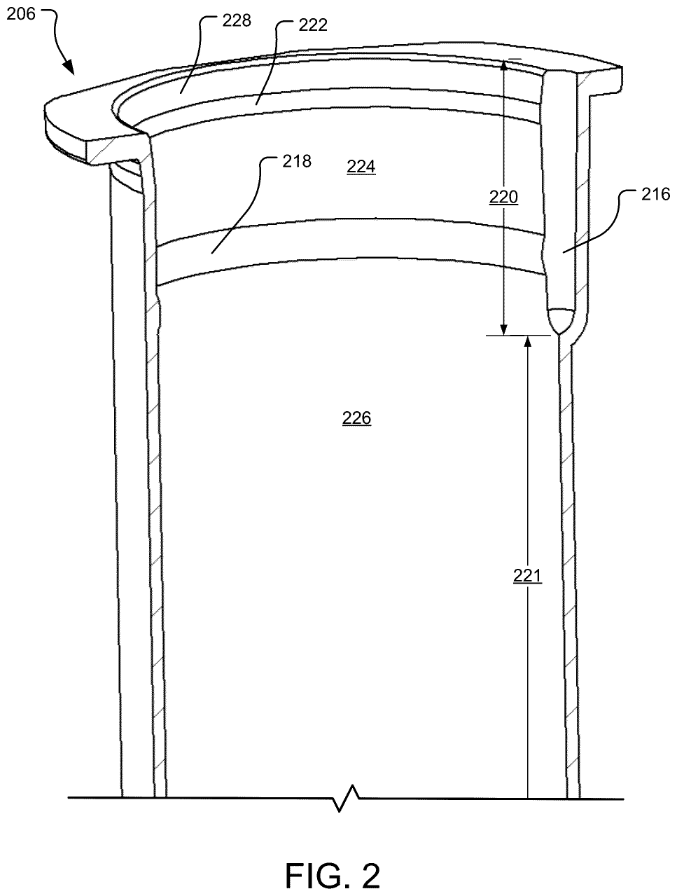

With the plunger 102 removed, an open input end 109 of the barrel 106 can be used to fill the barrel 106 with liquid sealant or other fluid. The open input end 109 is also equipped with a vent port 116 that defines a priming section 124 as distinct from a main section 126 of the barrel 106, as discussed in further detail with reference to FIG. 2 below. The barrel 106 includes a variety of features to allows its reuse and minimize mess, as discussed in detail below, when the plunger 102 is removed from the barrel 106 (e.g., to fill the barrel 106 with liquid sealant) and/or replaced within the barrel (e.g., after filling the barrel 106 with liquid sealant).

More specifically, the plunger 102 can be linearly pulled and pushed along the inside of the barrel 106, as illustrated by arrow 114. This allows the plunger 102 to be removed from the barrel 106 so that the barrel 106 may be filled with fluid. The plunger 102 may then be inserted into the barrel 106 and depressed through the priming section 124 of the barrel 106 to prime the injector 100. The plunger 102 may then be further depressed through the main section 126 of the barrel 106 to expel liquid tire sealant therein through a discharge port 108 at a discharge end 110 of the barrel 106. The discharge port 108 of the injector 100 is fitted with an output hose 112, a distal end of which is fitted with the chuck 104.

In some implementations, the chuck 104 is of a unitary construction of a resiliently deflectable material (e.g., a plastic or rubber) that allows it to interference fit with a variety of valve stem types and sizes. In other implementations, the chuck 104 includes multiple parts, including internal portions that are of the resiliently deflectable material that allow for the interference fit. The chuck 104 may be molded, formed, machined, assembled, or otherwise manufactured to meet the performance requirements. The chuck 104 may further include an integral textured handle 105 that allows a user to grip the chuck 104. The chuck 104 includes a variety of additional features (e.g., dual internal diameters) to allow its fitment to variety of valve stem types and sizes, while minimizing mess, when used to fill a pneumatic tubeless tire with sealant, as discussed in further detail below.

FIG. 2 illustrates a partial perspective sectional view of an example tapered-entry barrel 206 for a reloadable tire sealant injector (not shown in full, see e.g., injector 100 of FIG. 1). When used in conjunction with a corresponding plunger (not shown, see e.g., plunger 402 of FIGS. 4A-4C), the tapered-entry barrel 206 forms the reloadable tire sealant injector. Angled entry (e.g., a starting chamfer, bevel, and/or fillet) 228 aids the user in initial insertion of the plunger within priming section 224 of the barrel 206. A further fillet 222 may transition the barrel 206 from the angled entry 228 to the remainder of the barrel 206 that mostly has a straight bore (e.g., aside from annular bump 218 and vent port 216).

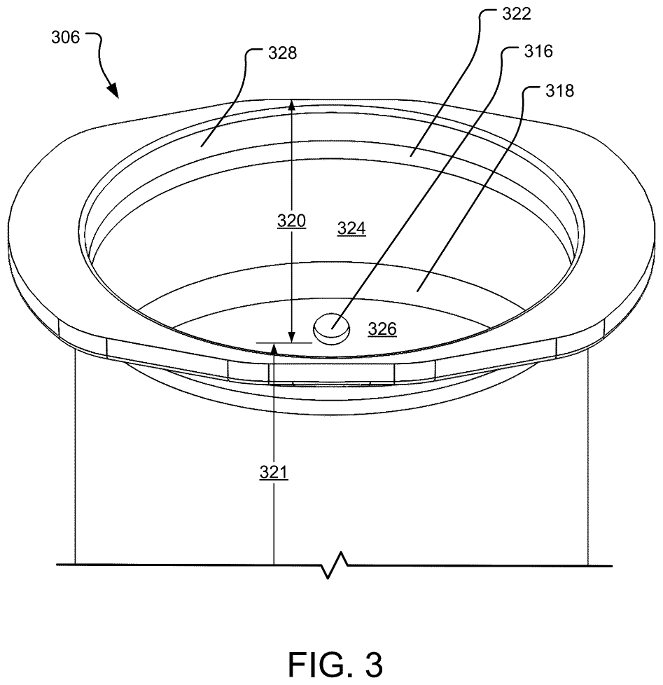

The priming section 224 extends axially along the barrel 206 from the depicted open end of the barrel 206, past angled entry 228 and the annular bump 218, to the start of vent port 216. Access of the contents of the barrel 206 to the vent port 216 when the plunger is depressed functionally defines the priming section 224 as distinct from a main section 226 of the barrel 206. The priming section 224 is visually illustrated by arrow 220 extending from the start of the vent port 216 to the depicted open end of the barrel 206. The vent port 216 extends longitudinally down the wall of the barrel 206 in the priming section 224. In other implementations (see e.g., FIG. 3), the vent port extends transversely through the wall of a barrel, as described in further detail below. The liquid sealant is less likely to spill out of the barrel 206 via the vent port 216 than a transverse hole vent port, which is a technical advantage of the vent port 216. The vent port 216 is also integrally formed in the barrel 206, rather than drilled or otherwise formed in the barrel 206 in a subsequent step, which is a further technical advantage of the vent port 216.

The main section 226 extends axially along the barrel 206 from the start of the vent port 216 to a discharge end (not shown, see e.g., discharge end 110 of FIG. 1) of the barrel 206, as illustrated by arrow 221. The annular bump 218 provides an increase resistance to movement of the plunger within the barrel 306 tactilely indicating to a user the transition between the priming section 224 and the main section 226. This allows the user to accurately place the plunger at the end of the priming section 224 or at the beginning of the main section 226 on either side of the annular bump 218. While the annular bump 218 is illustrated as an annular feature on an interior surface of the barrel 206, a similar functionality may be achieved by other geometric features within the barrel 206, such as a partially annular bump, singular or set of raised bumps or other shapes that interface with the plunger to provide tactile feedback to the user. In addition, during a draw-back step, the user may draw the plunger back to the annular bump 218 (the lower extent of it) to normalize pressure in a vessel that sealant was injected into.

In operation, the user fills the main section 226 with a desired amount of liquid sealant. If the user wishes to maximize sealant volume or minimize or eliminate air within the injector, the user fills the entire main section 226 up to the start of the vent port 216. After filling the main section 226 with liquid sealant, the user inserts the plunger into the angled entry 228, which helps to guide the plunger into the priming section 224 of the barrel 206. This is technically advantageous over prior re-useable barrel designs that lack the angled entry 228 as sharp edges otherwise present at an open end of a conventional barrel can cause insertion of a plunger into the conventional body to be difficult, thereby increasing the potential for an inadvertent liquid sealant spillage or ejection.

As the user further depresses the plunger through the length of the priming section 224, air escapes from the barrel 206 via the vent port 216, thereby allowing the user to depress the plunger within the priming section 224 without pressurizing the liquid sealant up to just past the annular bump 218. This allows the user to prime the injector by discharging substantially all the air within the barrel 206 via the vent port 216 without losing much, if any sealant either through the vent port 216 or through the discharge end of the barrel 206. This is technically advantageous over prior re-useable barrel designs that lack the priming section 224 in that the contents of a conventional barrel are instantly pressurized upon initial insertion of the plunger. Given an upright orientation of injector containing liquid sealant, this may result in unwanted pressurization of the liquid sealant and ejection of a wasted amount of the liquid sealant through the discharge end of the conventional barrel.

After the tire sealant injector is primed (e.g., by depressing the plunger through the priming section 224), the user may further depress the plunger through the length of the main section 226, thereby discharging liquid sealant from a discharge port (not shown, see e.g., discharge port 108 of FIG. 1) in the barrel 206. As examples, the priming section 224 may be 10-50 mm long and the angled entry 228 may be less than 10 mm long. The overall length of the barrel 206 may be 70-300 mm long and 15-100 mm in diameter, providing a volume between 12 mL and 2500 mL. The foregoing dimensions are provided as examples and are not intended to limit the presently disclosed technology.

FIG. 3 illustrates an open end of another example tapered-entry barrel 306 for a reloadable tire sealant injector (not shown in full, see e.g., injector 100 of FIG. 1). When used in conjunction with a corresponding plunger (not shown, see e.g., plunger 402 of FIGS. 4A-4C), the tapered-entry barrel 306 forms the reloadable tire sealant injector. Angled entry (e.g., a starting chamfer, bevel, and/or fillet) 328 aids the user in initial insertion of the plunger within priming section 324 of the barrel 306. A further fillet 322 may transition the barrel 306 from the angled entry 328 to the remainder of the barrel 306 that mostly has a straight bore (e.g., aside from annular bump 318).

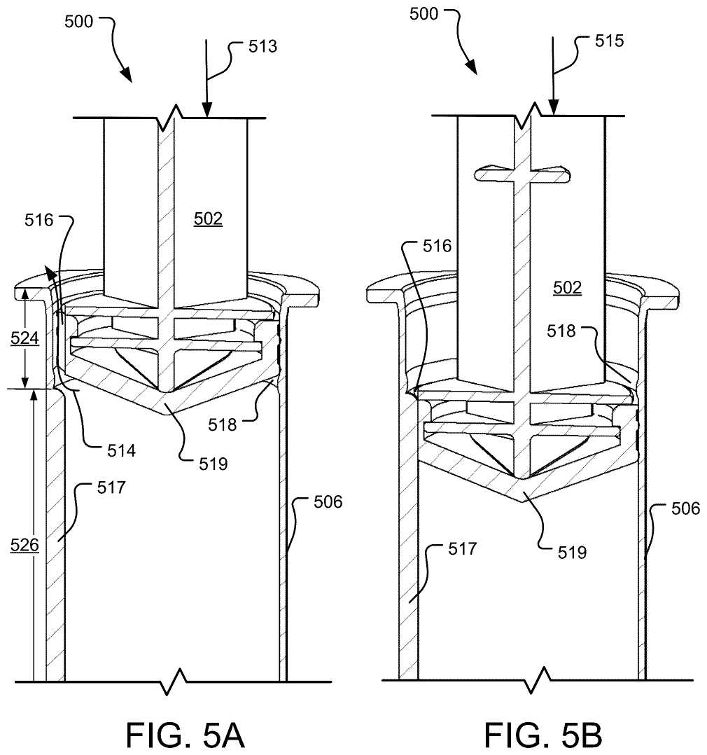

The priming section 324 extends axially along the barrel 306 from the depicted open end of the barrel 306, past angled entry 328 and the annular bump 318, to vent port 316. Access of the contents of the barrel 306 to the vent port 316 when the plunger is depressed functionally defines the priming section 324 as distinct from a main section 326 of the barrel 306. The priming section 324 is visually illustrated by arrow 320 extending from a bottom of the vent port 316 to the depicted open end of the barrel 306. The vent port 316 extends axially through the wall of the barrel 302 at an end of the priming section 324. Other implementations may configure the vent port 316 on the plunger rather than the barrel 306 (see e.g., FIGS. 5A-5B and detailed description thereof below).

The main section 326 extends axially along the barrel 306 from the start of the vent port 316 to a discharge end (not shown, see e.g., discharge end 110 of FIG. 1) of the barrel 306, as illustrated by arrow 321. The annular bump 318 provides an increased resistance to movement of the plunger within the barrel 306 tactilely indicating to a user the transition between the priming section 324 and the main section 326. This allows the user to accurately place the plunger at the end of the priming section 324 or at the beginning of the main section 326 on either side of the annular bump 318.

FIG. 4A illustrates a partial elevation sectional view of a plunger 402 removed from a tapered-entry barrel 406 of an example reloadable tire sealant injector (not shown in full, see e.g., injector 100 of FIG. 1). The barrel 406 is a hollow tube (e.g., a cylinder) with a fully open input end (as depicted in FIGS. 4A-4C) and mostly closed discharge end (not shown, see e.g., discharge end 110 of FIG. 1), excepting a discharge port (also not shown, sec e.g., discharge port 108 of FIG. 1). The barrel 406 includes an angled entry 428 that aids a user in initial insertion of the plunger 402 into the barrel 406. An optional fillet 422 may transition the barrel 406 from the angled entry 428 to the remainder of the barrel 406 that mostly has a straight bore (e.g., aside from annular bump 418).

A priming section 424 extends axially along the barrel 406 from the depicted open end of the barrel 406, past the angled entry 428 and the annular bump 418, to the start of vent port 416. The vent port 416 extends longitudinally down the wall of the barrel 406 in the priming section 424. A main section 426 extends axially along the barrel 406 from the start of the vent port 416 to the discharge end of the barrel 406. The barrel 406 may also include one or more additional features as discussed above with reference to at least FIGS. 2-3.

The plunger 402 includes a handle end (not shown, see e.g., handle end 101 of FIG. 1) and the depicted opposing plunger end, which includes a resilient tip 419 that deflects and conforms with internal walls of the barrel 406 to seal the exterior concentric surfaces of the plunger 402 to interior concentric surfaces of the barrel 406, even as the plunger 402 moves with reference to the barrel 406. The resilient tip 419 may include rings (e.g., ring 421) or other structures to aid in sealing against the barrel 406. With the plunger 402 removed, as shown in FIG. 4A, the depicted open input end of the barrel 406 can be used to gravity fill the main section 426 of the barrel 406 with a desired amount of liquid sealant or other fluid, up to the start of vent port 416 or below.

FIG. 4B illustrates the plunger 402 positioned within the tapered-entry barrel 406 and above an annular bump 418 of the example reloadable tire sealant injector of FIG. 4A. After filling the main section 426 with liquid sealant or other fluid, the user inserts the plunger 402 into the angled entry 428, which helps to guide the plunger 402 into the priming section 424 of the barrel 406, as illustrated by arrow 413. The resilient tip 419 of the plunger 402 deflects and conforms with internal walls of the barrel 406 to seal the exterior concentric surfaces of the plunger 402 to interior concentric surfaces of the barrel 406 with the exception of an area occupied by the vent port 416, which is left open to allow air to escape from the barrel 406.

More specifically, as the user further depresses the plunger through the length of the priming section 424, the air escapes from the barrel 406 via the vent port 416, as illustrated by arrow 414. This allows the user to depress the plunger 402 within the priming section 424 without pressurizing the liquid sealant up to just past the annular bump 418. The injector is therefore primed by discharging substantially all the air within the barrel 406 via the vent port 416 without losing much, if any sealant either through the vent port 416 or through the discharge end of the barrel 406.

FIG. 4C illustrates the plunger 402 positioned within the tapered-entry barrel 406 and below the annular bump 418 of the example reloadable tire sealant injector of FIGS. 4A and 4B. The resilient tip 419 of the plunger 402 deflects and conforms with internal walls of the barrel 406 within the main section 426 to seal the exterior concentric surfaces of the plunger 402 to interior concentric surfaces of the barrel 406. The vent port 416 is no longer used once the plunger 402 is within the main section 426.

After the tire sealant injector is primed (e.g., by depressing the plunger 402 through the priming section 424 and past the vent port 416), the user may further depress the plunger 402 through the length of the main section 426, as illustrated by arrow 415, thereby pressurizing the barrel 406 and discharging liquid sealant from a discharge port (not shown, see e.g., discharge port 108 of FIG. 1) in the barrel 406.

FIG. 5A illustrates a partial elevation sectional view of a plunger 502 positioned within a barrel 506 with its resilient tip 519 above an annular bump 518 of another example reloadable tire sealant injector 500. The barrel 506 is a hollow tube (e.g., a cylinder) with a fully open input end (as depicted in FIGS. 5A-5B) and mostly closed discharge end (not shown, see e.g., discharge end 110 of FIG. 1), excepting a discharge port (also not shown, sec e.g., discharge port 108 of FIG. 1). A priming section 524 extends axially along the barrel 506 from the depicted open end of the barrel 506 to the start of vent port plug 517. A main section 526 extends axially along the barrel 506 from the start of the vent port plug 517 to the discharge end of the barrel 506. The vent port plug 517 is a protrusion that extends longitudinally down the wall of the barrel 506 in the main section 526. The barrel 506 may also include one or more additional features as discussed above with reference to at least FIGS. 2-3.

The plunger 502 includes a handle end (not shown, see e.g., handle end 101 of FIG. 1) and the depicted opposing plunger end. The resilient tip 519 deflects and conforms with internal walls of the barrel 506 to seal the exterior concentric surfaces of the plunger 502 to interior concentric surfaces of the barrel 506, even as the plunger 502 moves with reference to the barrel 406. The resilient tip 519 includes a vent port 516 that permits air from the barrel 506 to pass by the plunger 502 when the vent port 516 is unfilled. The vent port 516 extends longitudinally down the resilient tip 519, and in some implementations, the plunger 502.

After filling the main section 526 with liquid sealant or other fluid, the plunger 502 is inserted into the barrel 506 and positioned above the annular bump 518 of the reloadable tire sealant injector 500. The resilient tip 519 of the plunger 502 deflects and conforms with internal walls of the barrel 506 to seal the exterior concentric surfaces of the plunger 502 to interior concentric surfaces of the barrel 506 with the exception of an area occupied by the vent port 516, which is left open to allow air to escape from the barrel 506.

As a user depresses the plunger 502 through the length of the priming section 524, as illustrated by arrow 513, the air escapes from the barrel 506 via the vent port 516, as illustrated by arrow 514. This allows the user to depress the plunger 502 within the priming section 524 without pressurizing the liquid sealant up to the vent port plug 517. The injector is therefore primed by discharging substantially all the air within the barrel 506 via the vent port 516 without losing much, if any sealant either through the vent port 516 or through the discharge end of the barrel 506.

FIG. 5B illustrates the plunger 502 positioned within the tapered-entry barrel 506 with its resilient tip 519 below the annular bump 518 of the example reloadable tire sealant injector 500 of FIG. 5A. The resilient tip 519 of the plunger 502 deflects and conforms with internal walls of the barrel 506 within the main section 526 to seal the exterior concentric surfaces of the plunger 502 to interior concentric surfaces of the barrel 506. A cross-section of the vent port plug 517 matches a cross-section of the vent port 516 so that the vent port 516 is filled in the main section 526 and no longer used once the resilient tip 519 of the plunger 502 enters the main section 526.

After the tire sealant injector is primed (e.g., by depressing the plunger through the priming section 524 and past the vent port 516), the user may further depress the plunger 502 through the length of the main section 526, as illustrated by arrow 515, thereby pressurizing the barrel 506 and discharging liquid sealant from a discharge port (not shown, see e.g., discharge port 108 of FIG. 1) in the barrel 506.

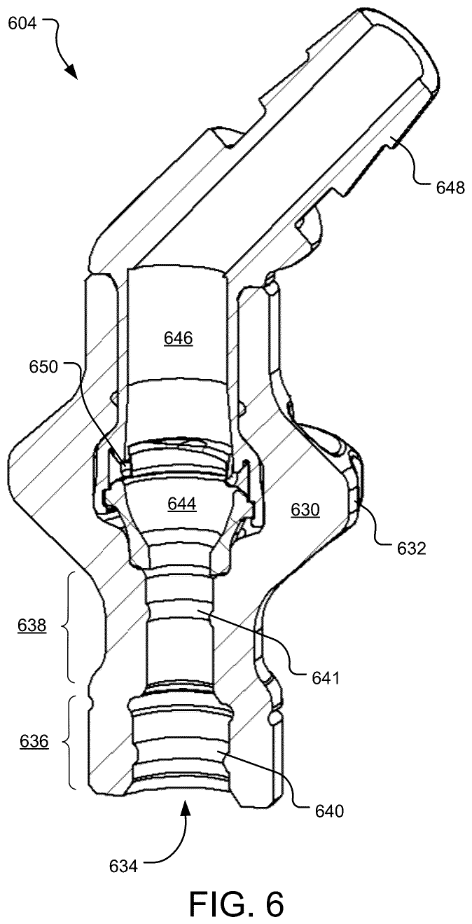

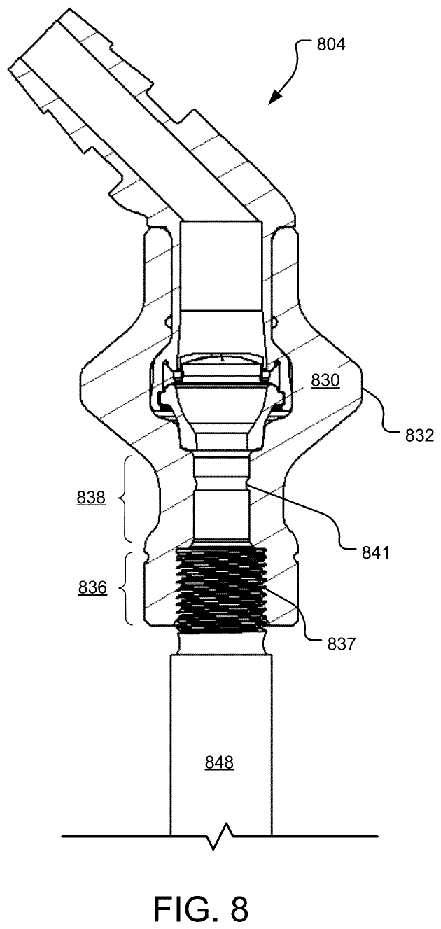

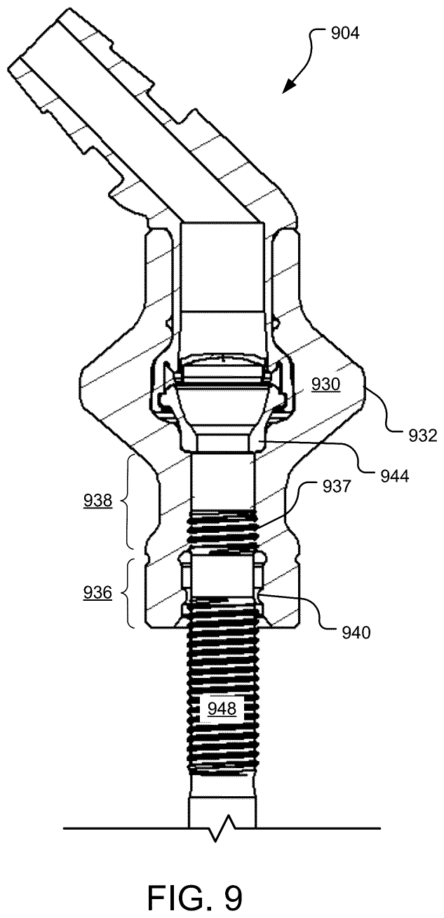

FIG. 6 illustrates a perspective sectional view of an example interference fit chuck 604 for a reloadable tire sealant injector (not shown in full, see e.g., injector 100 of FIG. 1). The chuck 604 includes a resilient housing 630 that covers other components of the chuck 604, in part or in whole, secures the other components to the resilient housing 630, and provides a structure for a user to grasp. To that end, the resilient housing 630 has an external flange 632 that allows the user to push the chuck 604 onto a valve stem (not shown, see e.g., valve stem 848 of FIG. 8 and valve stem 948 of FIG. 9) by applying an installation force and pull the chuck 604 from the valve stem by applying a removal force. Other implementations may achieve this functionality with shapes other than a flange, such as a spherical bulge, square or other prismatically shaped bumps, indents, or other graspable shapes.

The chuck 604 is interference fit or otherwise attached to a hose adaptor 646, which may include an angled barb 648, that allows the chuck 604 to be connected to an output hose (not shown see e.g., output hose 112 of FIG. 1) of the reloadable tire sealant injector. The resilient housing 630 includes an aperture 634 that interference fits with the valve stem as well. As compared to conventional adapters that screw onto the valve stem, the interference fit of the aperture 634 allows an easier fitment of the chuck 604 to the valve stem without twisting or turning the chuck 604 and related output hose, barrel, and plunger (not shown, see e.g., output hose 112, barrel 106, and plunger 102 of FIG. 1).

The aperture 634 is of a stepped design to accommodate multiple valve stem sizes. For example, a first section 636 is of an internal diameter and length appropriate to interference fit with a larger Schrader valve stem (e.g., valve stem 848 of FIG. 8), while a second section 638 is of an internal diameter appropriate to interference fit with a smaller Presta valve stem (e.g., valve stem 948 of FIG. 9). Additional sections within the aperture 634 to accommodate different or additional valve stem types are contemplated herein. As a result, the chuck 604 does not require any adapters or configuration changes to be fit to different valve stem types, as is the case for many conventional designs. The resilient housing 630 is of a resiliently deflectable material, such as a rubber (e.g., natural or synthetic) to provide a fluid-tight seal against the valve stem. The resilient housing 630 further includes integrated internal stem seals 640, 641 extending generally circumferentially about the aperture 634 in the first section 636 and the second section 638, respectively that aid in providing the fluid-tight seal against the valve stem.

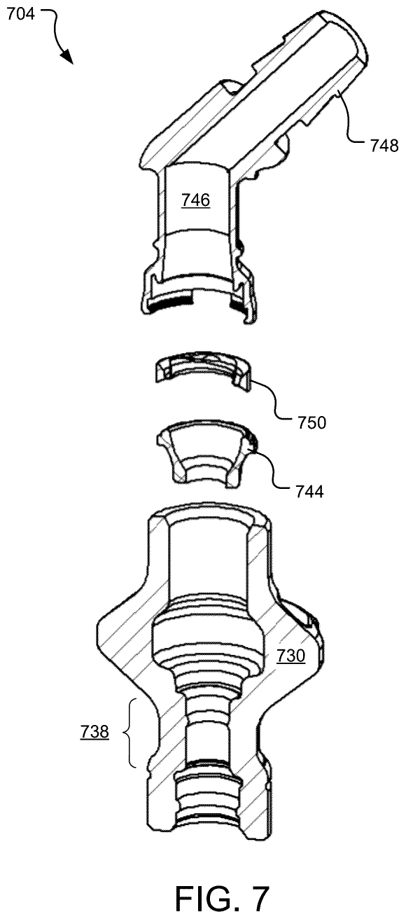

Other components of the chuck 604 (e.g., a relief valve 650 and an adaptor orifice 644) are present in FIG. 6 but better illustrated in FIG. 7 and thus described in detail with reference to FIG. 7 below.

FIG. 7 illustrates an exploded perspective sectional view of another example interference fit chuck 704 for a reloadable tire sealant injector (not shown in full, see e.g., injector 100 of FIG. 1). The chuck 704 includes a resilient housing 730 that when assembled with the other depicted components of the chuck 704 secures the other components to the resilient housing 730 and provides a structure for a user to grasp.

The chuck 704 is interference fit or otherwise attached to a hose adaptor 746 that allows the chuck 704 to be connected to an output hose (not shown see e.g., output hose 112 of FIG. 1) of the reloadable tire sealant injector. Conventional chuck designs are often in-line with the output hose, which can make access difficult in tight spaces, such as with small wheels and/or tightly packed spokes or electric bicycles that adopt hub-type electric motors that feature large shell/flange diameters. The depicted angled hose barb 748 for the hose adaptor 746 allows for access to the side in tight spaces, which improves usability of the chuck 704. While illustrated at about 45-degrees in FIGS. 6-9, in other implementations, the angled hose barb 748 could be angled anywhere between 0 and 180 degrees from a valve stem. The output hose stretches over the angled hose barb 748 when the reloadable tire sealant injector is assembled. Other implementations adopt a different connection between the hose adaptor 746 and the output hose.

Seated between the resilient housing 730 and the hose adaptor 746, and within the resilient housing 730 is an adaptor orifice 744. The adaptor orifice 744 smoothly expands the inner diameter of the chuck 704 from that provided by second section 738 of the resilient housing 730 to that of the remainder of the chuck 704, specifically the inner diameter of a relief valve 750 and the hose adaptor 746. The adaptor orifice 744 may be more rigid than the surrounding resilient housing 730 and help to maintain a large minimum diameter at the chuck's narrowest point. The relatively large and centrally located thru-hole design established by the adaptor orifice 744 is further substantially maintained through the output hose to the barrel (not shown, see e.g., output hose 112, and barrel 106 of FIG. 1).

In contrast, conventional designs often have one or more smaller thru-holes or rigid valve orifices, which may or may not be centrally located within a correspond chuck. These designs are susceptible to clogging with particulates or coagulated sealant. The larger and centrally located thru-hole design of the presently disclosed designs is less susceptible to such clogging. In some implementations, a lower inner diameter limit of the adaptor orifice 744 is 3 mm in diameter, with a practical range between 3 mm and 5 mm. Conventional designs often have an orifice size less than 3 mm.

The relief valve 750 is seated to the hose adaptor 746 and secured between the hose adaptor 746 and the adaptor orifice 744 within the resilient housing 730. The relief valve 750 is employed as a bi-directional pressure relief to reduce unwanted spillage of liquid sealant prior to attachment of the chuck 704 to the valve stem and after removal of the chuck 704 from the valve stem. The relief valve 750 may be of various styles (e.g., cross-slit, duckbill, umbrella, shim-type, etc.). An appropriately specified relief valve 750 cooperates with the remainder of the injector to permit the user to draw the plunger back and depress it again (also referred to herein as cycling the injector) without having to disconnect the chuck from the valve stem. This allows the user to expel substantially all the fluid sealant from the injector. In other implementations, the relief valve 750 is unidirectional (i.e., functioning as a check valve) to prevent unwanted spillage of liquid sealant from the reloadable tire sealant injector without permitting cycling of the injector while connected to the valve stem.

Conventional designs tend to leak or ooze liquid sealant due to residual pressure differentials between a barrel/plunger and an open chuck and/or gravity. To address this issue, some conventional designs incorporate a valve to close the output hose, such as a pinch valve, a lever-actuated ball valve, etc. However, these valves are often unreliable, cumbersome to use, and require positive action by a user to be effective. Further, due to their relative size, such valves are often located a significant distance from the valve stem interface, which yields a larger fluid volume (potential spillage), between valve and end of the chuck as compared to the presently disclosed design that incorporates the relief valve 750 within the resilient housing 730. The presently disclosed design is reliable and requires no particular action on the part of the user to function. The relief valve 750 automatically closes and remains closed until sufficient pressure (or pressure exceeding a threshold) is applied to open the relief valve 750, particularly from compressive actuation of a plunger of the reloadable tire sealant injector.

FIG. 8 illustrates a sectional view of another example interference fit chuck 804 for a reloadable tire sealant injector (not shown in full, see e.g., injector 100 of FIG. 1) attached to a Schrader valve stem 848. The chuck 804 includes a resilient housing 830 that covers other components of the chuck 804, in part or in whole, secures the other components to the resilient housing 830, and provides a structure for a user to grasp. To that end, the resilient housing 830 has an external flange 832 that allows the user to push the chuck 804 onto the valve stem 848 and pull the chuck 804 from the valve stem 848.

The resilient housing 830 includes a central aperture that interference fits with the valve stem 848 and is of a stepped design to accommodate multiple valve stem sizes. For example, a first section 836 is of an internal diameter and length appropriate to interference fit with the larger Schrader valve stem 848, while a second section 838 is of an internal diameter appropriate to interference fit with a smaller Presta valve stem (not shown, see e.g., valve stem 948 of FIG. 9). The resilient housing 830 may include an integrated internal stem seal (not shown, similar to stem seal 841) extending generally circumferentially about the aperture in the first section 836 that aids in providing a fluid-tight seal against the valve stem 848 at stem/housing interface 837.

Further, the valve stem 848 may bottom out within the resilient housing 830 against the second section 838 to provide an affirmative stop indicating that the valve stem 848 is fully seated within the resilient housing 830. In some implementations, this also provides a sealing mechanism between the resilient housing 830 and the valve stem 848 in addition to or in lieu of an integrated internal stem seal.

FIG. 9 illustrates a sectional view of another example interference fit chuck 904 for a reloadable tire sealant injector (not shown in full, see e.g., injector 100 of FIG. 1) attached to a Presta valve stem 948. The chuck 904 includes a resilient housing 930 that covers other components of the chuck 904, in part or in whole, secures the other components to the resilient housing 930, and provides a structure for a user to grasp. To that end, the resilient housing 930 has an external flange 932 that allows the user to push the chuck 904 onto the valve stem 948 and pull the chuck 904 from the valve stem 948.

The resilient housing 930 includes a central aperture that interference fits with the valve stem 948 and is of a stepped design to accommodate multiple valve stem sizes. For example, a first section 936 is of an internal diameter and length appropriate to interference fit with a larger Schrader valve stem (not shown, see e.g., valve stem 848 of FIG. 8), while a second section 938 is of an internal diameter appropriate to interference fit with the smaller Presta valve stem 948. The resilient housing 930 may include an integrated internal stem seal (not shown, similar to stem seal 940) extending generally circumferentially about the aperture in the second section 938 that aids in providing a fluid-tight seal against the valve stem 948 at stem/housing interface 937.

Further, the valve stem 948 may bottom out within the resilient housing 930 against adapter orifice 944 (described above) to provide an affirmative stop indicating that the valve stem 948 is fully seated within the resilient housing 930. In some implementations, this also provides a sealing mechanism between the resilient housing 930 and the valve stem 948 in addition to or in lieu of an integrated internal stem seal.

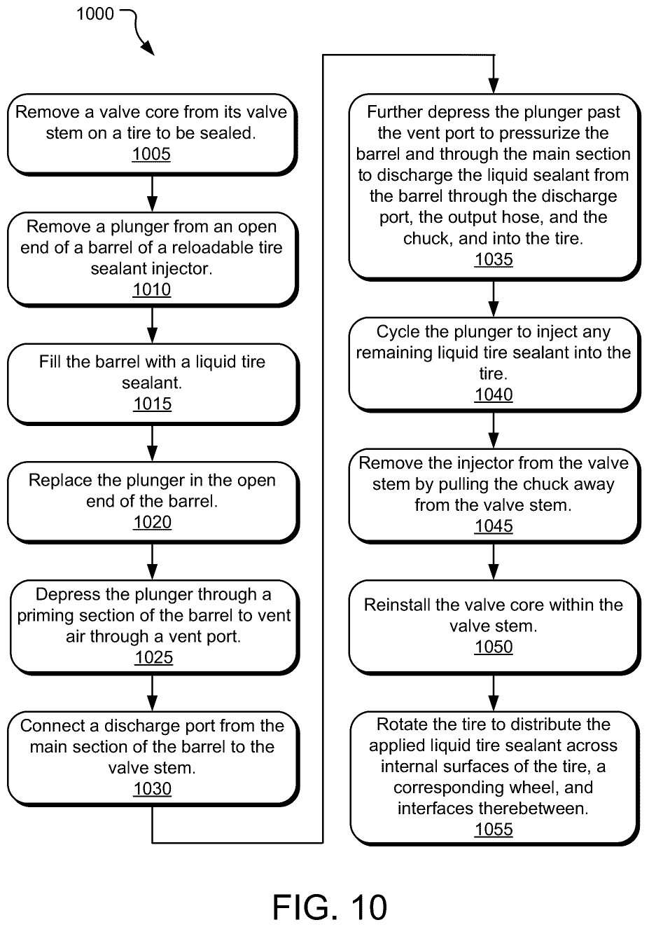

FIG. 10 illustrates example operations 1000 for using a reloadable tire sealant injector to seal a pneumatic tubeless bicycle tire. A first removing operation 1005 removes a valve core from its valve stem on the tire. The valve stem may be a Schrader, Presta, Dunlop, or custom valve stem. A second removing operation 1010 removes a plunger from an open end of a barrel of the reloadable tire sealant injector. The barrel includes a priming section and a main section. A vent port defines a transition between the priming section and the main section of the barrel.

A filling operation 1015 fills the barrel with a liquid tire sealant. In various implementations, a user may consult the sealant volume chart provided with the reloadable tire sealant injector or the liquid tire sealant to define an amount of the liquid tire sealant to use. The liquid tire sealant may come in a bulk container that is first shaken to evenly distribute constituent components and poured in the barrel up to a volume line on the barrel corresponding to the desired amount of the liquid tire sealant.

When the barrel receives the liquid tire sealant, the user needs a way to close a discharge end of the injector to prevent spillage. Prior solutions utilize a valve on a discharge hose or a cap near a chuck of the injector. These closures require additional steps, such as opening/closing a valve or adding/removing a cap, which can be easily forgotten or done improperly. The injector disclosed herein is technically advantageous in that it uses a relief valve to perform this function, which requires no additional steps performed by the user.

Prior solutions may allow the user to suck liquid tire sealant out of the bulk container to fill the barrel instead of pouring the liquid tire sealant into the barrel as provided by filling operation 1015. This may result in an inadequate mix of constituent components within the liquid tire sealant as it is sucked into the barrel, thereby reducing its effectiveness. The presently disclosed interference fit chuck is technically advantageous in that it includes a resilient housing sized and shaped so that it does not fit into a typical liquid tire sealant bottle neck, thereby compelling a user to use the filling operation 1015 to fill the barrel. So long as the user adequately shakes the bulk container beforehand, the liquid tire sealant is properly mixed prior to being poured into the barrel.

A replacing operation 1020 replaces the plunger in the open end of the barrel. Sharp edges of a conventional barrel can make replacing the plunger difficult or awkward. Thus, the presently disclosed barrel is technically advantageous in that it may include an angled entry to aid the replacing operation 1020. A first depressing operation 1025 depresses the plunger through the priming section to vent air through the vent port.

Absent the vent port, the depressing operation 1025 would pressurize the injector, forcing liquid tire sealant out through the interference fit chuck. The presently disclosed vent port is technically advantageous in that it alleviates pressure buildup by bleeding air out of the barrel as the user depresses the plunger through the priming section. The plunger is depressed until its leading edge reaches an annular bump inside the injector body indicating the end of the priming section. The annular bump is technically advantageous in that it may be viewable in a clear or translucent barrel and tactilely felt by the user experiencing a sharp increase in resistive force to the depressing operation 1025. The operations 1010-1025 may be performed at a workbench or other suitable location for the user to comfortably work, which may be away from the tire. This is technically advantageous over conventional designs that may require some or all of corresponding operations to be performed while the injector is connected to the tire.

A connecting operation 1030 connects a discharge port from the main section of the barrel to the valve stem. To aid the connecting operation 1030, the discharge port from the main section of the barrel is fluidly connected to an output hose, which in turn is fluidly connected to the interference fit chuck. The output hose allows the interference fit chuck to be repositioned and reoriented semi-independently from the barrel of the injector, increasing the flexibility of performing the connecting operation 1030 overall. The interference fit chuck may also include an angled hose attachment to improve use access to the valve stem in tight wheel/tire spaces.

The chuck is pressed onto the valve stem to create an interference fit between the valve stem and the resilient housing of the chuck. The resilient housing includes a first section to interference fit with a first valve stem type and a second section to interference fit with a second valve stem type. The valve stem is one of the first valve stem type and the second valve stem type, and thus interference fits with the chuck. Other implementations may utilize greater or fewer sections to interference fit with greater or fewer valve stem types.

In conventional injector designs, to avoid a pressure increase within the barrel caused by priming the plunger, a user may leave the plunger removed from the barrel when connecting the chuck to the valve stem. The resulting open top barrel is at risk of spilling while connecting the chuck to the valve stem. Further, some conventional chucks are threaded for a screw-on attachment to the valve stem, thus requiring the user to rotate the chuck (and the entire injector), thus creating lots of movement of the barrel. This movement may dislodge the pressurized plunger from the top of the barrel and create a further risk of spilling.

Alternatively, a user may avoid the foregoing risks of spilling by attaching the injector to the valve stem prior to filling it. However, this is disadvantageous in that operations corresponding to operations 1010-1025 are then performed adjacent the tire, which may be an awkward or uncomfortable location for the user to work. The presently disclosed injector is technically advantageous over conventional designs because it reduces or eliminates the foregoing risks of spilling, while allowing the user to perform the operations 1010-1025 at a workbench or other suitable location for the user to comfortably work.

A further depressing operation 1035 further depresses the plunger past the vent port to pressurize the barrel and through the main section to discharge the liquid sealant from the barrel through the discharge port, the output hose, and the chuck, and into the tire. The user generally presses down on the plunger until all of the liquid tire sealant within the barrel has been injected into the valve stem.

Many conventional injectors are too small to hold an adequate sealant volume to repair the tire in one application (e.g., less than 100 mL). This requires the user to repeat the corresponding sequence of operations more than once. The presently disclosed barrel holds a larger volume than many conventional injectors e.g., greater than 100 mL, or approximately 150 mL), thereby allowing a user to perform the operations 1000 once to inject sealant into the tire. In other applications, the barrel may hold a sufficient volume so that operations 1010-1025 may be performed once to inject sealant into multiple tires.

The relief valve is normally closed and actuates at an actuation pressure that exceeds that within the barrel as the plunger is depressed through the priming section. The actuation pressure is met or exceeded when the plunger is depressed through the main section. As a result, the relief valve prevents liquid sealant from passing through the resilient housing (by holding the liquid sealant in the resilient housing) when depressing the plunger through the priming section. The relief valve allows the liquid sealant to pass through the resilient housing (by releasing the liquid sealant through the resilient housing) when depressing the plunger past the vent port and through the main section.

A cycling operation 1040 cycles the plunger to inject any remaining liquid tire sealant into the tire. The relief valve allows the user to cycle the plunger to ensure all sealant has cleared the hose and made it into their tire. In implementations that utilize a check valve in place of the relief valve, the user is prevented from performing the cycling operation 1040. Some conventional chucks have small orifices or off-center passages or utilize valves with similar small orifices or off-center passages (e.g., shim-type valves) that can get clogged by sealant and/or particulate. A clog is a hassle to remove and typically will waste liquid tire sealant. The presently disclosed chuck is technically advantageous in that it has a large, centrally located opening and may utilize a relief valve type (e.g., cross-slit or duckbill) that has a similarly large and central opening to prevent clogs.

A removing operation 1045 removes the injector from the valve stem by pulling the chuck away from the valve stem. When removing a conventional injector (with or without a hose valve) from the valve stem, residual liquid tire sealant within the barrel, output hose, and/or chuck drips out of the chuck when it is removed from the valve stem. This is caused by a volume of sealant that remains between the hose valve and the valve stem. Further, the hose valve (if present) requires an additional step of closing prior to removing the chuck from the tire valve, as discussed above. In lieu of the hose valve found in conventional designs, placement of the relief valve in the presently disclosed chuck near the valve stem is technically advantageous in that it allows the chuck to be removed from the valve stem with very little or no liquid tire sealant spillage.

A reinstalling operation 1050 reinstalls the valve core within the valve stem. A rotating operation 1055 rotates the tire to distribute the applied liquid tire sealant across internal surfaces of the tire, a corresponding wheel, and interfaces therebetween. As the liquid tire sealant cures, the tire is sealed.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A reloadable tire sealant injector comprising:
a barrel to receive liquid tire sealant, the barrel including:
a priming section including an open end;
a main section including a discharge port;
a vent port that defines a transition between the priming section and the main section of the barrel; and
a plunger to be inserted into the open end of the priming section, depressed through the priming section to vent air through the vent port, depressed past the vent port to pressurize the barrel, and depressed through the main section to discharge the liquid tire sealant from the barrel through the discharge port.

2. The reloadable tire sealant injector of claim 1, wherein the open end of the barrel includes an angled entry for insertion of the plunger.

3. The reloadable tire sealant injector of claim 1, further comprising:
an annular bump on an interior surface of a wall of the barrel indicating a transition between the priming section and the main section of the barrel.

4. The reloadable tire sealant injector of claim 1, wherein the vent port extends longitudinally down an interior surface of a wall of the barrel in the priming section.

5. The reloadable tire sealant injector of claim 1, wherein the vent port extends transversely through a wall of the barrel between the priming section and the main section.

6. The reloadable tire sealant injector of claim 1, wherein the vent port extends longitudinally down the plunger, and wherein the vent port matches a vent port plug extending longitudinally down an interior surface of a wall of the barrel in the main section.

7. An interference fit chuck for a tire sealant injector comprising:
a resilient housing including:
a first section to interference fit with a first valve stem type; and
a second section to interference fit with a second valve stem type; and
a relief valve within the resilient housing to:
hold liquid sealant within the resilient housing when less than a actuation pressure is applied; and
release the liquid sealant when greater than the actuation pressure is applied.

8. The interference fit chuck of claim 7, wherein the resilient housing is a unitary molded structure.

9. The interference fit chuck of claim 7, wherein the resilient housing further includes an external flange for applying installation and removal force to the interference fit chuck.

10. The interference fit chuck of claim 7, further comprising:
a hose adapter for attaching an output hose extending from a barrel of a reloadable tire sealant injector.

11. The interference fit chuck of claim 10, wherein the relief valve is secured within the resilient housing between the hose adapter and an orifice internal to the resilient housing.

12. The interference fit chuck of claim 10, wherein the hose adapter includes an angled hose barb.

13. The interference fit chuck of claim 7, wherein the relief valve is one of a cross-slit, duckbill, umbrella, or a shim-type valve.

14. A method of using a reloadable tire sealant injector comprising:
remove a plunger from an open end of a barrel of the reloadable tire sealant injector, the barrel including a priming section and a main section;
fill the barrel with a liquid tire sealant;
replace the plunger in the open end of the barrel;
depress the plunger through the priming section to vent air through a vent port that defines a transition between the priming section and the main section of the barrel;
connect a discharge port from the main section of the barrel to a valve stem of a pneumatic tire; and
further depress the plunger past the vent port to pressurize the barrel and through the main section to discharge the liquid tire sealant from the barrel through the discharge port, and into the pneumatic tire.

15. The method of claim 14, wherein connecting the discharge port to the valve stem is performed by fitting an interference fit chuck to the valve stem of the pneumatic tire, the interference fit chuck including a resilient housing with a first section to interference fit with a first valve stem type and a second section to interference fit with a second valve stem type, the valve stem of the pneumatic tire being of one of the first valve stem type and the second valve stem type.

16. The method of claim 15, further comprising:
holding liquid sealant within the resilient housing when less than an actuation pressure is applied by depressing the plunger through the priming section.

17. The method of claim 16, further comprising:
releasing the liquid sealant through the resilient housing when greater than the actuation pressure is applied by depressing the plunger past the vent port and through the main section.

18. The method of claim 15, wherein an output hose connects the discharge port of the barrel to the interference fit chuck.

19. The method of claim 18, further comprising:
cycling the plunger to discharge residual liquid tire sealant within the barrel, the output hose, and the interference fit chuck into the pneumatic tire.

20. A reloadable tire sealant injector comprising:
a barrel to receive liquid tire sealant, the barrel including:
a priming section including an open end; and
a main section including a discharge port;
a vent port that defines a transition between the priming section and the main section of the barrel;
a resilient housing including:
a first section to interference fit with a first valve stem type; and
a second section to interference fit with a second valve stem type;
a plunger to be inserted into the open end of the priming section, depressed through the priming section to vent air through the vent port, depressed past the vent port to pressurize the barrel, and depressed through the main section to discharge liquid tire sealant from the barrel through the discharge port, through the resilient housing, and into a pneumatic tire; and
a relief valve within the resilient housing to:
hold the liquid tire sealant within the resilient housing when less than a actuation pressure is applied by depressing the plunger through the priming section; and
release the liquid tire sealant through the resilient housing and into the pneumatic tire when greater than the actuation pressure is applied by depressing the plunger past the vent port and through the main section.
